(19) United States
(12) Patent Application Publication
(10) Pub. No.: US 2025/0275047 A1
(43) Pub. Date: Aug. 28, 2025

(54) SOLID TARGET SUBSTANCE REPLENISHMENT DEVICE, EXTREME ULTRAVIOLET LIGHT GENERATION APPARATUS, AND ELECTRONIC DEVICE MANUFACTURING METHOD

(71) Applicant: Gigaphoton Inc., Tochigi (JP)

(72) Inventors: Takuya ISHII, Oyama-shi (JP); Yuto TANAKA, Oyama-shi (JP)

(73) Assignee: Gigaphoton Inc., Tochigi (JP)

(21) Appl. No.: 19/016,421

(22) Filed: Jan. 10, 2025

(30) Foreign Application Priority Data
Feb. 22, 2024 (JP) 2024-025770

(51) Int. Cl. H05G 2/00

(52) U.S. Cl. CPC H05G 2/0023; H05G 2/0082

(57) ABSTRACT

A solid target substance replenishment device includes a solid target container, a first path through which a solid target substance passes, a delivery device, and a second path through which the solid target substance delivered by the delivery device is replenished to a molten target container. The delivery device includes a tube including a receiving port for receiving the solid target substance having passed through the first path and a facing surface; a delivery rod delivering the solid target substance; and a stopper forming a passage through which the solid target substance between the receiving port and the facing surface is moved in the tube by being moved toward an outside of the tube when the delivery rod moves forward, and restrict the target substance from returning between the receiving port and the facing surface by being moved toward an inside of the tube when the delivery rod moves backward.

### CROSS-REFERENCE TO RELATED APPLICATIONS

The present application claims the benefit of Japanese Patent Application No. 2024-025770, filed on Feb. 22, 2024, the entire contents of which are hereby incorporated by reference.

### BACKGROUND

### 1. Technical Field

The present disclosure relates to a solid target substance replenishment device, an extreme ultraviolet light generation apparatus, and an electronic device manufacturing method.

### 2. Related Art

Recently, miniaturization of a transfer pattern in optical lithography of a semiconductor process has been rapidly proceeding along with miniaturization of the semiconductor process. In the next generation, microfabrication at 10 nm or less will be required. Therefore, it is expected to develop an exposure apparatus that combines an extreme ultraviolet (EUV) light generation apparatus that generates EUV light having a wavelength of about 13 nm and reduced projection reflection optical system.

As the EUV light generation apparatus, a laser produced plasma (LPP) type apparatus using plasma generated by irradiating a target substance with laser light has been developed.

### LIST OF DOCUMENTS

### Patent Documents

Patent Document 1: US Patent Application Publication No. 2023/0008733
Patent Document 2: Japanese Patent Application Publication No. H07-051419
Patent Document 3: Japanese Patent Application Publication No. 2003-164553
Patent Document 4: Japanese Patent Application Publication No. H10-146452
Patent Document 5: Japanese Patent Application Publication No. H08-071208
Patent Document 6: Japanese Patent Application Publication No. 2007-020646

### SUMMARY

A solid target substance replenishment device according to an aspect of the present disclosure includes a solid target container configured to contain a solid target substance, a first path through which the solid target substance supplied from the solid target container passes, a delivery device, and a second path through which the solid target substance delivered by the delivery device is replenished to a molten target container of an extreme ultraviolet light generation apparatus. Here, the delivery device includes a tube including a receiving port for receiving the solid target substance having passed through the first path and a facing surface facing the receiving port; a delivery rod configured to deliver the solid target substance in the tube by being caused to alternately move forward and backward in a length direction of the tube; and a stopper configured to form a passage through which the solid target substance between the receiving port and the facing surface is moved in the tube by being moved toward an outside of the tube when the delivery rod moves forward, and restrict the target substance in the tube from returning between the receiving port and the facing surface by being moved toward an inside of the tube when the delivery rod moves backward.

An electronic device manufacturing method according to an aspect of the present disclosure includes generating extreme ultraviolet light using an extreme ultraviolet light generation apparatus, outputting the extreme ultraviolet light to an exposure apparatus, and exposing a photosensitive substrate to the extreme ultraviolet light in the exposure apparatus to manufacture an electronic device. Here, the extreme ultraviolet light generation apparatus includes a solid target substance replenishment device; a molten target container configured to melt the solid target substance replenished by the solid target substance replenishment device to produce a molten target substance; a nozzle configured to output the molten target substance produced in the molten target container; a laser device configured to irradiate, with pulse laser light, the molten target substance having reached a predetermined region after being output from the nozzle; and an EUV light concentrating mirror configured to concentrate the extreme ultraviolet light emitted from plasma generated in the predetermined region. The solid target substance replenishment device includes a solid target container configured to contain a solid target substance, a first path through which the solid target substance supplied from the solid target container passes, a delivery device, and a second path through which the solid target substance delivered by the delivery device is replenished to the molten target container of the extreme ultraviolet light generation apparatus. The delivery device includes a tube including a receiving port for receiving the solid target substance having passed through the first path and a facing surface facing the receiving port; a delivery rod configured to deliver the solid target substance in the tube by being caused to alternately move forward and backward in a length direction of the tube; and a stopper configured to form a passage through which the solid target substance between the receiving port and the facing surface is moved in the tube by being moved toward an outside of the tube when the delivery rod moves forward, and restrict the target substance in the tube from returning between the receiving port and the facing surface by being moved toward an inside of the tube when the delivery rod moves backward.

An electronic device manufacturing method according to an aspect of the present disclosure includes inspecting a defect of a mask by irradiating the mask with extreme ultraviolet light generated by an extreme ultraviolet light generation apparatus, selecting a mask using a result of the inspection, and exposing and transferring a pattern formed on the selected mask onto a photosensitive substrate. Here, the extreme ultraviolet light generation apparatus includes a solid target substance replenishment device, a molten target container configured to melt the solid target substance replenished by the solid target substance replenishment device to produce a molten target substance, a nozzle configured to output the molten target substance produced in the molten target container, a laser device configured to irradiate, with pulse laser light, the molten target substance having reached a predetermined region after being output from the nozzle, and an EUV light concentrating mirror configured to concentrate the extreme ultraviolet light emitted from plasma generated in the predetermined region. The solid target substance replenishment device includes a solid target container configured to contain a solid target substance, a first path through which the solid target substance supplied from the solid target container passes; a delivery device, and a second path through which the solid target substance delivered by the delivery device is replenished to the molten target container of the extreme ultraviolet light generation apparatus. The delivery device includes a tube including a receiving port for receiving the solid target substance having passed through the first path and a facing surface facing the receiving port; a delivery rod configured to deliver the solid target substance in the tube by being caused to alternately move forward and backward in a length direction of the tube; and a stopper configured to form a passage through which the solid target substance between the receiving port and the facing surface is moved in the tube by being moved toward an outside of the tube when the delivery rod moves forward, and restrict the target substance in the tube from returning between the receiving port and the facing surface by being moved toward an inside of the tube when the delivery rod moves backward.

### BRIEF DESCRIPTION OF THE DRAWINGS

Embodiments of the present disclosure will be described below merely as examples with reference to the accompanying drawings.

FIG. 1 shows the configuration of an LPP EUV light generation system.

FIG. 2 shows the configuration of a droplet target generation device in the EUV light generation system according to a comparative example.

FIG. 3 shows the configuration and operation of delivery device according to the comparative example.

FIG. 4 shows the configuration and operation of the delivery device according to the comparative example.

FIG. 5 shows the configuration and operation of the delivery device according to the comparative example.

FIG. 6 shows the configuration and operation of the delivery device according to the comparative example.

FIG. 7 shows a state in the middle of forward movement of a delivery rod in the comparative example.

FIG. 8 shows a state in the middle of the forward movement of the delivery rod in the comparative example.

FIG. 9 schematically shows the configuration of the delivery device according to a first embodiment.

FIG. 10 shows the configuration of the delivery device according to the first embodiment.

FIG. 11 shows the operation of the delivery device according to the first embodiment.

FIG. 12 shows the operation of the delivery device according to the first embodiment.

FIG. 13 shows the operation of the delivery device according to the first embodiment.

FIG. 14 shows the operation of the delivery device according to the first embodiment.

FIG. 15 shows the configuration of the delivery device according to a second embodiment.

FIG. 16 is a sectional view of a tapered portion of a stopper according to a first modification of the second embodiment.

FIG. 17 is a sectional view of the tapered portion of the stopper according to a second modification of the second embodiment.

FIG. 18 shows the configuration of a droplet target generation device of a third embodiment.

FIG. 19 shows the configuration of an exposure apparatus connected to the EUV light generation system.

FIG. 20 shows the configuration of an inspection apparatus connected to the EUV light generation system.

### DESCRIPTION OF EMBODIMENTS

### <Contents>

1. Overall description of EUV light generation system 11
   1.1 Configuration
2. Comparative Example
   1.2 Operation
   2.1 Configuration of droplet target generation device
      2.1.1 Solid target substance replenishment device 260
      2.1.2 Molten target container C3
      2.1.3 Nozzle 52
   2.2 Operation of droplet target generation device 26
   2.3 Configuration of delivery device 8
   2.4 Operation of delivery device 8
   2.5 Problem of comparative example
3. Delivery device 8a with stopper 82 inclined
   3.1 Configuration of delivery device 8a
   3.2 Operation of delivery device 8a
   3.3 Effect
4. Delivery device 8b in which stopper 82 moves linearly
   4.1 Configuration and operation
   4.2 Effect
5. Delivery device 8b in which first surface 821 includes groove
   5.1 Configuration and operation
   5.2 Effect
6. Solid target substance replenishment device 260c including first and second detectors D1, D2
   6.1 Configuration
   6.2 Operation
   6.3 Effect
7. Others
   7.1 EUV light utilization apparatus 6
   7.2 Supplement

Hereinafter, embodiments of the present disclosure will be described in detail with reference to the drawings. The embodiments described below show some examples of the present disclosure and do not limit the contents of the present disclosure. Also, all configurations and operation described in the embodiments are not necessarily essential as configurations and operation of the present disclosure. Here, the same components are denoted by the same reference numeral, and duplicate description thereof is omitted.

### 1. Overall Description of EUV Light Generation System 11

### 1.1 Configuration

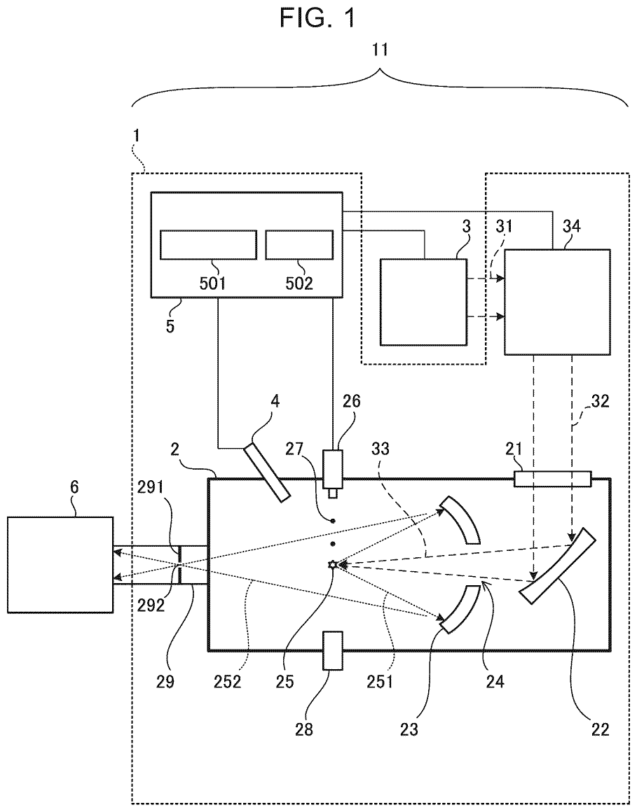

FIG. 1 shows the configuration of an LPP EUV light generation system 11. An EUV light generation apparatus 1 is used together with a laser device 3. In the present disclosure, a system including the EUV light generation apparatus 1 and the laser device 3 is referred to as the EUV light generation system 11. The EUV light generation apparatus 1 includes a chamber 2 and a droplet target generation device 26. The chamber 2 is a sealable container. The droplet target generation device 26 supplies a target 27 containing a target substance into the chamber 2. The material of the target substance may include tin, terbium, gadolinium, lithium, xenon, or a combination of any two or more thereof.

A through hole is formed in a wall of the chamber 2. The through hole is blocked by a window 21 and pulse laser light 32 output from the laser device 3 is transmitted through the window 21. An EUV light concentrating mirror 23 having a spheroidal reflection surface is arranged in the chamber 2. The EUV light concentrating mirror 23 has first and second focal points. A multilayer reflection film in which molybdenum and silicon are alternately stacked is formed on a surface of the EUV light concentrating mirror 23. The EUV light concentrating mirror 23 is arranged such that the first focal point is located in a plasma generation region 25 and the second focal point is located at an intermediate focal point 292. A through hole 24 is formed at the center of the EUV light concentrating mirror 23, and pulse laser light 33 passes through the through hole 24.

The EUV light generation apparatus 1 includes an EUV light generation processor 5, a target sensor 4, and the like. The EUV light generation processor 5 is a processing device including a memory 501 in which a control program is stored and a central processing unit (CPU) 502 which executes the control program. The EUV light generation processor 5 is specifically configured or programmed to perform various processes included in the present disclosure. The target sensor 4 detects at least one of the presence, trajectory, position, and velocity of the target 27. The target sensor 4 may have an imaging function.

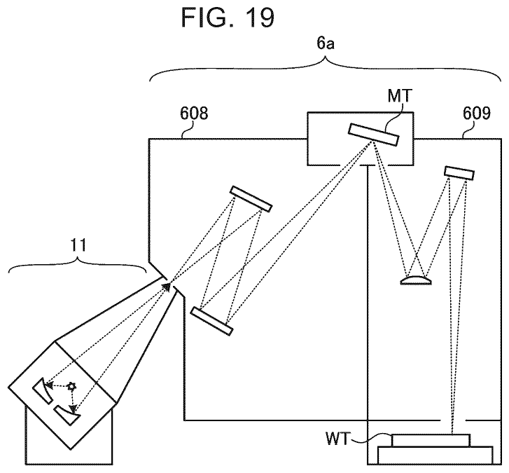

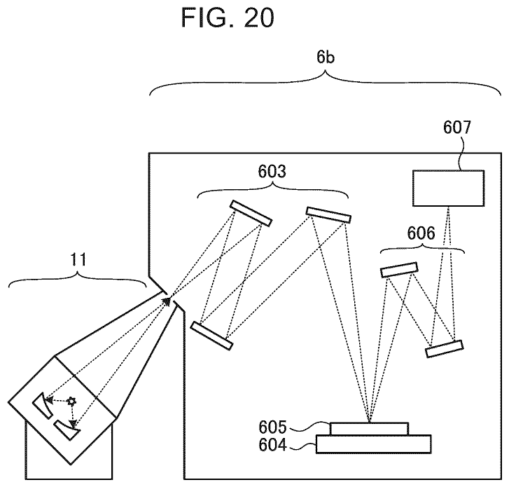

Further, the EUV light generation apparatus 1 includes a connection portion 29 providing communication between the internal space of the chamber 2 and the internal space of an EUV light utilization apparatus 6. The EUV light utilization apparatus 6 may be an exposure apparatus 6a shown in FIG. 19 or an inspection apparatus 6b shown in FIG. 20. A wall 291 in which an aperture is formed is arranged in the connection portion 29. The wall 291 is arranged such that the aperture is located at the second focal point of the EUV light concentrating mirror 23.

Further, the EUV light generation apparatus 1 includes a laser light transmission device 34, a laser light concentrating mirror 22, a target collection unit 28 for collecting the target 27, and the like. The laser light transmission device 34 includes an optical element for defining a transmission state of the pulse laser light 32, and an actuator for adjusting the position, posture, and the like of the optical element.

### 1.2 Operation

Operation of the EUV light generation system 11 will be described with reference to FIG. 1. Pulse laser light 31 output from the laser device 3 enters, via the laser light transmission device 34, the chamber 2 through the window 21 as the pulse laser light 32. The pulse laser light 32 travels along a laser light path in the chamber 2, is reflected by the laser light concentrating mirror 22, and is radiated to the target 27 as the pulse laser light 33.

The droplet target generation device 26 outputs the target 27 toward the plasma generation region 25 in the chamber 2. The target 27 is irradiated with the pulse laser light 33. The target 27 irradiated with the pulse laser light 33 is turned into plasma, and radiation light 251 is radiated from the plasma. The EUV light contained in the radiation light 251 is reflected by the EUV light concentrating mirror 23 with higher reflectance than light in other wavelength ranges. Reflection light 252 including the EUV light reflected by the EUV light concentrating mirror 23 is concentrated at the intermediate focal point 292 and output to the EUV light utilization apparatus 6. Here, one target 27 may be irradiated with a plurality of pulses included in the pulse laser light 33.

The EUV light generation processor 5 controls the entire EUV light generation system 11. The EUV light generation processor 5 processes a detection result of the target sensor 4. Based on the detection result of the target sensor 4, the EUV light generation processor 5 controls the timing at which the target 27 is output, the output direction of the target 27, and the like. Further, the EUV light generation processor 5 controls an oscillation timing of the laser device 3, the travel direction of the pulse laser light 32, the concentration position of the pulse laser light 33, and the like. Such various kinds of control described above are merely exemplary, and other control may be added as necessary.

### 2. Comparative Example

### 2.1 Configuration of Droplet Target Generation Device 26

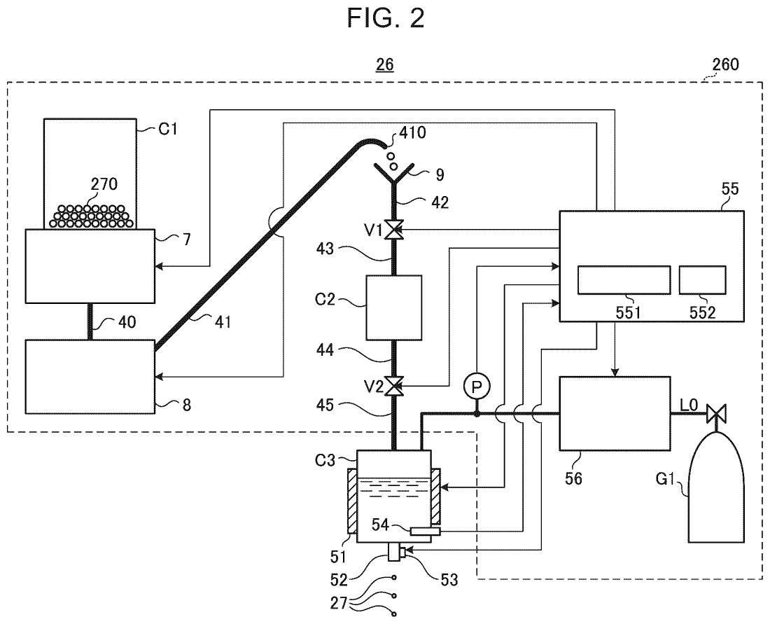

FIG. 2 shows the configuration of the droplet target generation device 26 in the EUV light generation system according to the comparative example. The comparative example of the present disclosure is an example recognized by the applicant as known only by the applicant, and is not a publicly known example admitted by the applicant. The droplet target generation device 26 includes a solid target substance replenishment device 260, a molten target container C3, and a nozzle 52.

### 2.1.1 Solid Target Substance Replenishment Device 260

The solid target substance replenishment device 260 includes a solid target container C1, a feed device 7, a delivery device 8, a funnel 9, a load lock chamber C2, a target supply processor 55, supply pipes 40 to 45, a gas cylinder G1, and a pressure regulator 56. The path of the solid target substance 270 configured by the feed device 7 and the supply pipe 40 corresponds to a first path through which the solid target substance 270 supplied from the solid target container C1 passes. The path of the solid target substance 270 from the supply pipe 41 to the supply pipe 45 corresponds to a second path for replenishing the solid target substance 270 delivered by the delivery device 8 to the molten target container C3.

The target supply processor 55 is a processing device including a memory 551 in which a control program is stored and a CPU 552 which executes the control program. The target supply processor 55 corresponds to the processor in the present disclosure. The target supply processor 55 is specifically configured or programmed to perform various processes included in the present disclosure.

The solid target container C1 is a container to contain the solid target substance 270 such as tin. The solid target substance 270 may be, for example, spherical particles of substantially the same size. The diameter of the solid target substance 270 is, for example, 2 mm or more and 5 mm or less. The temperature in the solid target container C1 is lower than the melting point of the target substance. The pressure in the solid target container C1 is about the same as the atmospheric pressure.

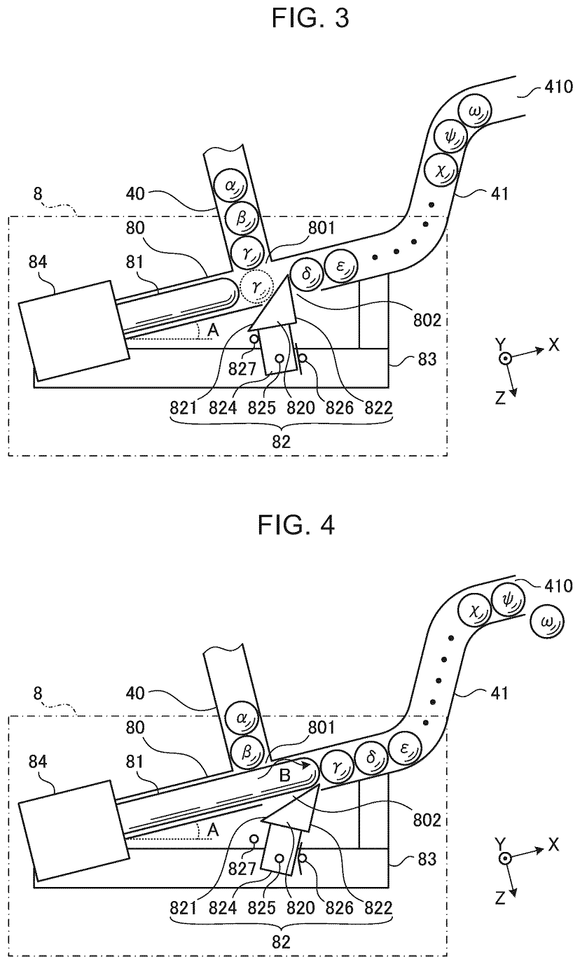

The feed device 7 is connected to the bottom of the solid target container C1, and connected to the delivery device 8 via the supply pipe 40. Details of the delivery device 8 will be described later with reference to FIGS. 3 to 6. The supply pipe 41 is arranged obliquely with respect to the gravity direction, and the delivery device 8 is connected to the lower end of the supply pipe 41. The funnel 9 is arranged below a discharge port 410 near the upper end of the supply pipe 41 as being spaced apart from the discharge port 410.

The funnel 9 has a conical shape whose diameter decreases toward the gravity direction, and the lower end thereof is connected to the load lock chamber C2 via the supply pipes 42, 43. A valve V1 is connected between the supply pipes 42, 43.

The load lock chamber C2 is a container to contain the solid target substance 270 supplied from the solid target container C1. The temperature in the load lock chamber C2 is lower than the melting point of the target substance. The load lock chamber C2 is connected to the molten target container C3 via the supply pipes 44, 45. A valve V2 is connected between the supply pipes 44, 45.

### 2.1.2 Molten Target Container C3

The molten target container C3 contains the target substance supplied from the load lock chamber C2. The molten target container C3 is connected to a gas cylinder G1 via a pressurized gas pipe LO. The gas cylinder G1 contains a high-pressure rare gas such as an argon gas or a helium gas as a pressurized gas. A pressure regulator 56 and a pressure gauge P is arranged at the pressurized gas pipe LO. The target supply processor 55 controls the pressure regulator 56 based on an output of the pressure gauge P, so that the pressure in the molten target container C3 is adjusted to a predetermined pressure higher than the atmospheric pressure.

A heater 51 and a level sensor 54 are arranged at the molten target container C3. The heater 51 is connected to a power source (not shown) and heats the inside of the molten target container C3 to a predetermined temperature higher than the melting point of the target substance. The temperature in the molten target container C3 is controlled by controlling the power source based on the output of a temperature sensor (not shown) arranged at the molten target container C3. As a result, the solid target substance 270 is melted in the molten target container C3 to generate a molten target substance. The level sensor 54 detects a liquid level position of the molten target substance in the molten target container C3.

### 2.1.3 Nozzle 52

The nozzle 52 is arranged at a lower end of the molten target container C3 in the gravity direction. The tip of the nozzle 52 is opened to the inside of the chamber 2 (see FIG. 1). A piezoelectric element 53 is arranged at the nozzle 52.

### 2.2 Operation of Droplet Target Generation Device 26

When the level sensor 54 detects that the liquid level position of the molten target substance in the molten target container C3 becomes below a threshold, the solid target substance 270 is replenished from the solid target container C1 as described below.

The target supply processor 55 opens the valve V1 with the valve V2 closed. Since the valve V2 is closed, the inside of the molten target container C3 is maintained at a high pressure. By opening the valve V1, the load lock chamber C2 is ready to receive the solid target substance 270.

The target supply processor 55 calculates the supply amount of the solid target substance 270 by the feed device 7 from the shortage amount of the molten target substance in the molten target container C3, and outputs a feed signal to the feed device 7. The feed device 7 feeds the solid target substance 270 one by one to the supply pipe 40 according to a feed signal. The target supply processor 55 does not output a subsequent feed signal until the replenishment of the solid target substance 270 to the molten target container C3 based on the latest feed signal is completed.

The delivery device 8 receives the solid target substance 270 from the supply pipe 40, and delivers the solid target substance 270 to the supply pipe 41 one by one at regular time intervals according to a control signal from the target supply processor 55.

The solid target substance 270 delivered from the delivery device 8 to the supply pipe 41 one by one is pressed by the solid target substance 270 delivered subsequently. As a result, the plurality of solid target substances 270 are successively moved in the supply pipe 41 against gravity, and are discharged from the discharge port 410 in order from the solid target substance 270 at the top.

The solid target substance 270 discharged from the discharge port 410 is received by the funnel 9 and flows into the supply pipe 42. The solid target substance 270 moves to the load lock chamber C2 through the open valve V1 and the supply pipe 43. When a desired amount of the solid target substances 270 is moved to the load lock chamber C2, the target supply processor 55 stops operation of the feed device 7 and the delivery device 8 and closes the valve V1.

Next, the target supply processor 55 opens the valve V2 to replenish the solid target substance 270 contained in the load lock chamber C2 to the molten target container C3. The solid target substance 270 moves from the load lock chamber C2 to the molten target container C3. The solid target substance 270 supplied to the molten target container C3 melts and mixes with the target substance already contained and melted in the molten target container C3. The heater 51 suppresses a decrease in the internal temperature of the molten target container C3.

When the valve V2 is opened, a portion of the gas in the molten target container C3 moves to the load lock chamber C2, and the pressure inside the molten target container C3 temporarily decreases. Since the valve V1 is closed before opening the valve V2, the high-pressure gas in the molten target container C3 is prevented from flowing from the valve V1 towards the funnel 9. Further, the pressurized gas in the gas cylinder G1 is supplied to the molten target container C3 via the pressure regulator 56, whereby the pressure in the molten target container C3 is recovered.

The molten target substance in the molten target container C3 is output from the opening at the tip of the nozzle 52 owing to the pressure difference between the pressurized gas supplied from the pressure regulator 56 and the pressure in the chamber 2. When vibration is applied to the nozzle 52 by the piezoelectric element 53, the jet-like molten target substance output from the nozzle 52 is separated into droplets to form the target 27.

According to the comparative example, the solid target substance 270 contained in the solid target container C1 having a substantially atmospheric pressure can be supplied into the molten target container C3 having a high pressure. Even when the target substance in the molten target container C3 is consumed, the target substance can be replenished without replacing the molten target container C3, so that the downtime of the EUV light generation apparatus 1 can be reduced.

### 2.3 Configuration of Delivery Device 8

FIGS. 3 to 6 show the configuration and operation of the delivery device 8 according to the comparative example. In FIGS. 3 to 6, the individual solid target substances 270 are denoted by the reference signs α to ω, and the reference numerals α to ω may be used to distinguish them. The delivery device 8 includes a tube 80, a delivery rod 81, a stopper 82, and a base portion 83.

The tube 80 has a cylindrical shape having a straight center axis, and includes a receiving port 801 for receiving the solid target substance 270 having passed through the feed device 7 and the supply pipe 40, and an entrance 802 facing the receiving port 801. The delivery rod 81 is located inside the tube 80 and configured to deliver the solid target substance 270 in the tube 80 by being caused to alternately move forward and backward in the length direction of the tube 80 by a drive unit 84.

The direction of the forward movement of the delivery rod 81 is defined as an X direction, the direction in which the solid target substance 270 passes through the receiving port 801 is defined as a Z direction, and one of the directions perpendicular to the X direction and the Z direction is defined as a Y direction. FIGS. 3 to 6 are views of the delivery device 8 viewed in the −Y direction. The tube 80 is supported by the base portion 83 at an angle A with respect to the horizontal direction, and connected to the supply pipe 41 having a larger inclination. The drive unit 84 is supported by the base portion 83.

The stopper 82 includes a tapered portion 820 and a rod portion 824. The tapered portion 820 is supported by the rod portion 824, and the rod portion 824 is supported by the base portion 83 via a rotation shaft 825. The rotation shaft 825 is parallel to the Y direction, and the stopper 82 is movable while pivoting in a plane parallel to an XZ plane.

The tapered portion 820 passes through the entrance 802 of the tube 80. The tapered portion 820 includes a first surface 821 and a second surface 822. The first surface 821 is inclined with respect to the X direction, and the second surface 822 intersects the X direction at an angle closer to perpendicular thereto than the angle between the X direction and the first surface 821.

The stopper 82 is provided with a counterclockwise rotational force in FIGS. 3 to 6 by the restoring force of the spring 826. When the delivery rod 81 moves forward in the X direction, the stopper 82 is pressed by the delivery rod 81 and pivots clockwise against the restoring force of the spring 826. When the delivery rod 81 is moved backward in the −X direction, the stopper 82 pivots counterclockwise by the restoring force of the spring 826, but when the stopper 82 abuts a stop pin 827, the counterclockwise pivot of the stopper 82 is restricted. At this time, the stopper 82 restricts the solid target substance δ in the tube 80 from returning in the −X direction. A space for receiving the solid target substance γ supplied from the receiving port 801 is secured between the receiving port 801 and the entrance 802.

### 2.4 Operation of Delivery Device 8

Referring to FIGS. 3 to 6, description is provided on the operation of the delivery device 8 to deliver the solid target substance γ waiting in the supply pipe 40 to the supply pipe 41. As a result of the delivery device 8 delivering the plurality of solid target substances 270 one by one, as shown in FIG. 3, it is assumed that the solid target substances δ to ω are already filled in the tube 80 and the supply pipe 41. When the delivery rod 81 moves backward to its most retracted position in the −X direction, the solid target substance γ moves into the space between the receiving port 801 and the entrance 802.

Thereafter, the delivery rod 81 moves in the X direction in the tube 80 and presses the first surface 821 of the stopper 82 via the solid target substance γ between the receiving port 801 and the entrance 802. As shown in FIG. 4, the stopper 82 pressed by the delivery rod 81 pivots clockwise in FIG. 4 against the restoring force of the spring 826, and most of the tapered portion 820 moves to the outside of the tube 80. Thus, a passage for moving the solid target substance γ in the X direction is formed in the tube 80.

The solid target substance γ is pressed by the delivery rod 81 moving in the X direction while being pressed against the wall surface on the −Z direction side in the tube 80 by receiving the reaction force from the inclined first surface 821 of the stopper 82, and moves in the tube 80 as indicated by an arrow B in FIG. 4. The solid target substance γ presses the solid target substances δ to ω. In this way, the delivery rod 81 delivers the solid target substances γ to ω against gravity, causing the solid target substance ω to be discharged from the discharge port 410.

As the solid target substance γ moves away from the first surface 821 by passing over the ridge line between the first surface 821 and the second surface 822 of the tapered portion 820, the stopper 82 pivots counterclockwise in FIG. 4 to the distal end position of the delivery rod 81 by the restoring force of the spring 826. That is, the passage of the solid target substance 270 in the tube 80 is maximized when the solid target substance γ passes over the ridge line between the first surface 821 and the second surface 822 of the tapered portion 820, and thereafter the tapered portion 820 moves toward the inside of the tube 80.

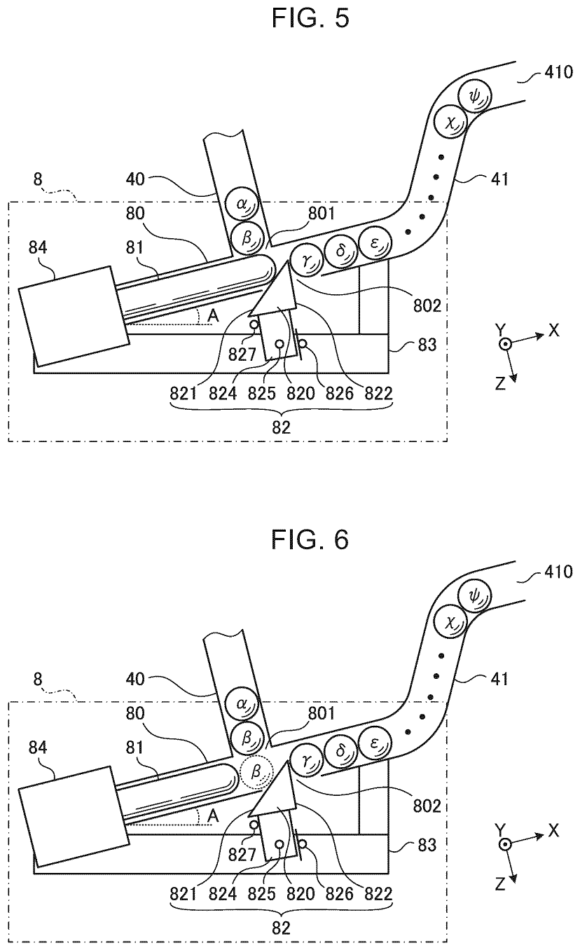

As shown in FIG. 5, when the delivery rod 81 starts moving in the −X direction, the stopper 82 pivots counterclockwise in FIG. 5 while being pressed against the delivery rod 81 by the restoring force of the spring 826, and the tapered portion 820 further moves toward the inside of the tube 80. At this time, since the solid target substance γ cannot pass over the ridge line between the first surface 821 and the second surface 822, it cannot return to the space between the receiving port 801 and the entrance 802, and is in contact with the second surface 822. The counterclockwise pivot of the stopper 82 is stopped by the stop pin 827.

As shown in FIG. 6, when the delivery rod 81 is moved to the position most retracted in the −X direction, the solid target substance β waiting in the supply pipe 40 moves to the space between the receiving port 801 and the entrance 802.

Thereafter, by repeating the operation described with reference to FIGS. 3 to 6, the solid target substance 270 is delivered one by one to the supply pipe 41.

### 2.5 Problem of Comparative Example

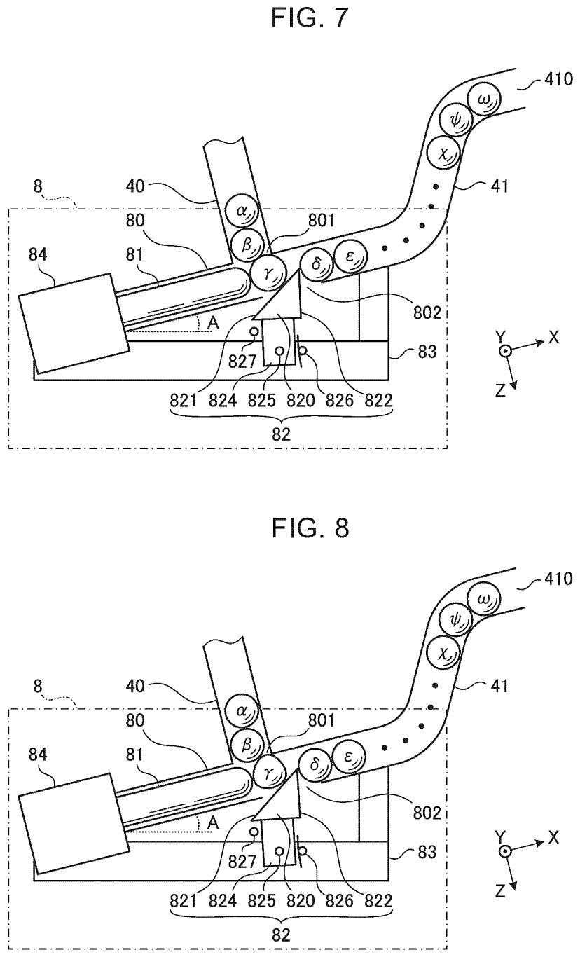

FIGS. 7 and 8 show a state in the middle of the forward movement of the delivery rod 81 in the comparative example. As described with reference to FIG. 4, the solid target substance γ pressed by the delivery rod 81 is pressed against the wall surface in the tube 80 by receiving the reaction force from the first surface 821. In some cases, the solid target substance γ is pressed against the edge of the receiving port 801, so that the solid target substance γ is surrounded by the edge of the receiving port 801, the delivery rod 81, and the first surface 821 to be immovable. The phenomenon that the solid target substance 270 becomes immovable in this manner is hereinafter referred to as “biting.”

The size of the solid target substance 270 is not completely uniform, and the shape thereof is not perfect sphere, and there are variations. As shown in FIG. 7, a large-diameter solid target substance γ may cause biting. As shown in FIG. 8, a non-spherical solid target substance γ may cause biting.

In each of FIGS. 7 and 8, if the delivery rod 81 is moved in the X direction with a sufficient force, a portion of the surface of the solid target substance γ is scraped off by the edge of the receiving port 801, and the biting may be eliminated. However, since the solid target substance Y is deformed when a portion of the surface of the solid target substance γ is scraped off, the deformed solid target substance γ may again cause biting or clogging somewhere in the second path. Further, scraping debris generated when a portion of the surface of the solid target substance γ is scraped may adhere to the rotation shaft 825 of the stopper 82 to increase friction, which may inhibit the operation of the stopper 82. The scraping debris may adhere to the inner wall surface of the tube 80 or the supply pipe 41, and clogging of the solid target substance 270 may occur.

Embodiments described below relate to stably replenishing the solid target substance 270 even when there are variations in the diameter and shape of the solid target substance 270.

### 3. Delivery Device 8a with Stopper 82 Inclined

### 3.1 Configuration of Delivery Device 8a

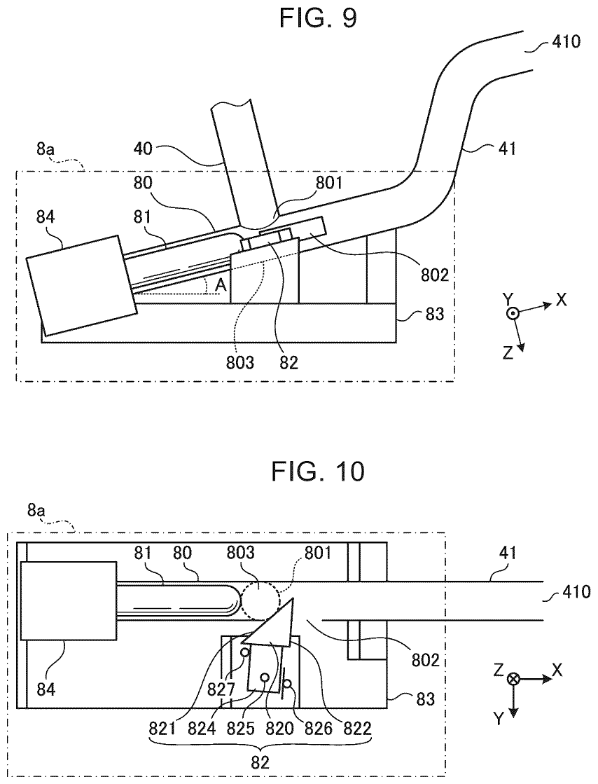

FIGS. 9 and 10 schematically show the configuration of the delivery device 8a according to a first embodiment. FIG. 9 is a view of the delivery device 8a viewed in the −Y direction, and FIG. 10 is a view of the delivery device 8a viewed in the Z direction. The tube 80 includes a facing surface 803 facing the receiving port 801. The facing surface 803 is a surface without the entrance 802 through which the stopper 82 enters and exits, and may be a cylindrical surface. The entrance 802 is not located at a position facing the receiving port 801, but is located on the Y-direction side perpendicular to both the direction in which the receiving port 801 and the facing surface 803 face each other and the length direction of the tube 80. The entrance 802 has a rectangular shape that is longer in the X direction than in the Z direction.

The stopper 82 is located on the Y direction side of the tube 80. The rotation shaft 825 is, for example, parallel to the Z direction, and the stopper 82 is pivotable in a plane intersecting the Z direction and pivotable in a plane away from the receiving port 801. More preferably, the stopper 82 is pivotable in a plane perpendicular to the Z direction.

The tapered portion 820 passes through the entrance 802. The stopper 82 is provided with a counterclockwise rotational force in FIG. 10 by the restoring force of the spring 826. The counterclockwise pivot of the stopper 82 is restricted by the stop pin 827.

### 3.2 Operation of Delivery Device 8a

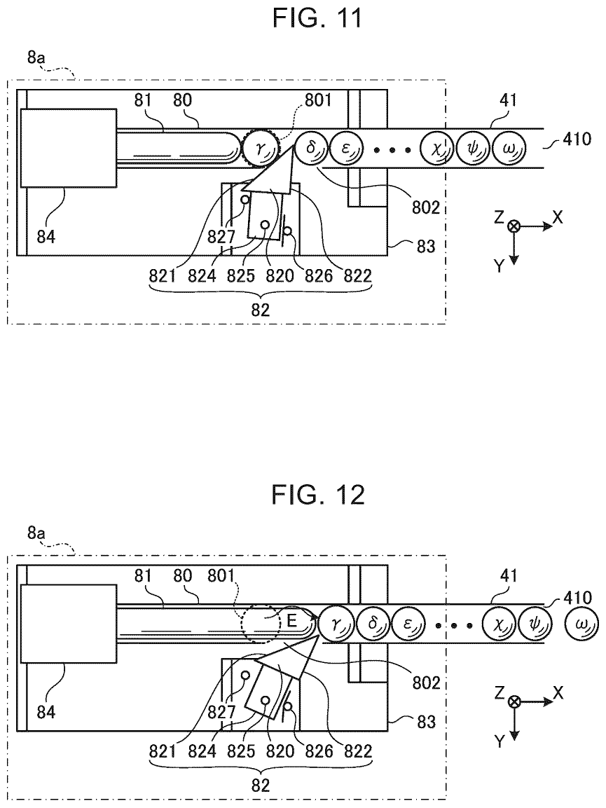

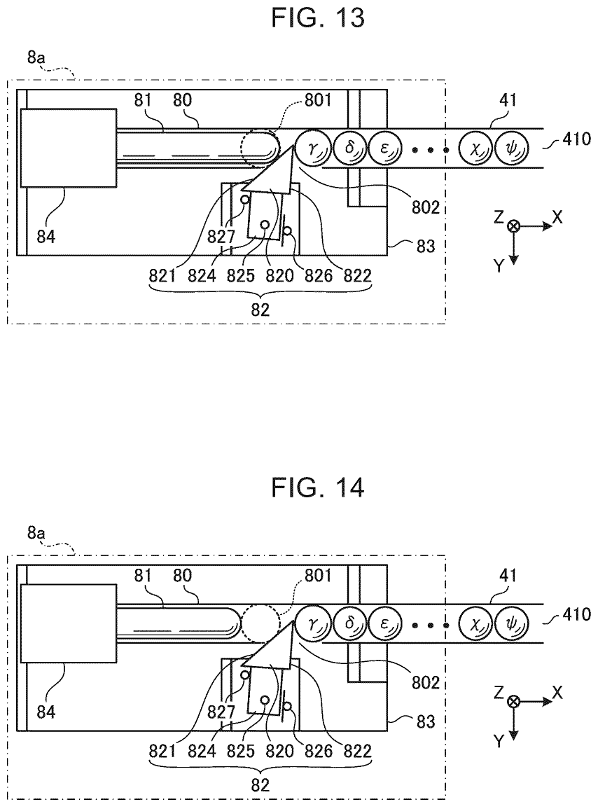

FIGS. 11 to 14 schematically show the operation of the delivery device 8a according to the first embodiment. FIGS. 11 to 14 are views of the delivery device 8a viewed in the Z direction, and show substantially the same operation as that of FIGS. 3 to 6, except that the stopper 82 is pivoted in a plane perpendicular to the Z direction.

When the delivery rod 81 moves forward in the X direction, the first surface 821 of the tapered portion 820 is pressed by the delivery rod 81 via the solid target substance γ, and the stopper 82 is moved toward the outside of the tube 80 by pivoting clockwise in FIGS. 11 to 14. Thus, the passage for moving the solid target substance γ between the receiving port 801 and the facing surface 803 in the tube 80 is formed.

Since the stopper 82 pivots in a plane perpendicular to the Z direction, the solid target substance γ moves in the tube 80 as indicated by an arrow E in FIG. 12 while being pressed against the wall surface on the −Y direction side in the tube 80. Since pressing against the wall surface on the −Z direction side is prevented, biting is suppressed even with the large-diameter solid target substance γ.

When the delivery rod 81 is moved backward in the −X direction, the stopper 82 pivots counterclockwise by the restoring force of the spring 826 and is moved toward the inside of the tube 80, but when the stopper 82 abuts the stop pin 827, the counterclockwise pivot of the stopper 82 is restricted. At this time, the second surface 822 restricts the solid target substance d in the tube 80 from returning in the −X direction. Further, by further moving the delivery rod 81 in the −X direction, a space for receiving the solid target substance γ supplied from the receiving port 801 is secured between the receiving port 801 and the facing surface 803 and between the delivery rod 81 and the stopper 82.

### 3.3 Effect

(1) According to the first embodiment, the solid target substance replenishment device 260 includes the solid target container C1, the feed device 7, the supply pipe 40, the delivery device 8a, and the path from the supply pipe 41 to the supply pipe 45. The solid target container C1 contains the solid target substance 270. The solid target substance 270 supplied from the solid target container C1 passes through the feed device 7 and the supply pipe 40. The delivery device 8a includes the tube 80, the delivery rod 81, and the stopper 82. The tube 80 includes the receiving port 801 for receiving the solid target substance 270 having passed through the feed device 7 and the supply pipe 40, and the facing surface 803 facing the receiving port 801. The delivery rod 81 delivers the solid target substance 270 in the tube 80 by being caused to alternately move forward and backward in parallel to the X direction being the length direction of the tube 80. When the delivery rod 81 moves forward in the X direction, the stopper 82 moves toward the outside of the tube 80, thereby forming a passage through which the solid target substance 270 between the receiving port 801 and the facing surface 803 is moved in the tube 80. When the delivery rod 81 moves backward in the −X direction, the stopper 82 moves toward the inside of the tube 80, thereby restricting the solid target substance 270 in the tube 80 from returning between the receiving port 801 and the facing surface 803. The path from the supply pipe 41 to the supply pipe 45 replenishes the solid target substance 270 delivered by the delivery device 8a to the molten target container C3 of the EUV light generation system 11.

Accordingly, it is possible to suppress biting of the solid target substance 270 at the edge of the receiving port 801 even when there are variations in the diameter and shape of the solid target substance 270.

(2) According to the first embodiment, the stopper 82 moves in a plane intersecting the Z direction, which is the moving direction of the solid target substance 270 passing through the receiving port 801.

Accordingly, the direction of the force received by the solid target substance 270 from the stopper 82 is deviated from the Z direction, which is the moving direction of the solid target substance 270 passing through the receiving port 801. Therefore, it is possible to suppress the solid target substance 270 from being pressed toward the receiving port 801 by the stopper 82, and suppress biting of the solid target substance 270 from occurring at the edge of the receiving port 801.

(3) According to the first embodiment, the stopper 82 moves in the XY plane perpendicular to the Z direction, which is the moving direction of the solid target substance 270 passing through the receiving port 801.

Accordingly, the direction of the force received by the solid target substance 270 from the stopper 82 is significantly deviated from the Z direction, which is the moving direction of the solid target substance 270 passing through the receiving port 801. Accordingly, it is possible to suppress biting of the solid target substance 270 at the edge of the receiving port 801.

(4) According to the first embodiment, the stopper 82 moves in a plane away from the receiving port 801.

Accordingly, since there is no receiving port 801 in the surface where the stopper 82 moves, it is possible to suppress the solid target substance 270 from being pressed toward the receiving port 801 by the stopper 82, and suppress biting of the solid target substance 270 from occurring at the edge of the receiving port 801.

(5) According to the first embodiment, the stopper 82 moves by being pressed by the delivery rod 81 when the delivery rod 81 moves forward in the X direction, and moves by the restoring force of the spring 826 when the delivery rod 81 moves backward in the −X direction.

Accordingly, it is possible to realize the movement of the stopper 82 by the forward and backward movement of the delivery rod 81.

(6) According to the first embodiment, the stopper 82 has the first surface 821 that is pressed to the delivery rod 81 via the solid target substance γ when the delivery rod 81 moves forward in the X direction.

Accordingly, both the solid target substance γ and the stopper 82 can be pressed together with the forward movement of the delivery rod 81.

(7) According to the first embodiment, the first surface 821 is inclined with respect to the X direction, which is the direction of the forward movement of the delivery rod 81.

Accordingly, it is possible to realize the movement of the stopper 82 in the Y direction by the forward movement of the delivery rod 81 in the X direction.

(8) According to the first embodiment, the stopper 82 has the second surface 822 that restricts the solid target substance γ pressed by the delivery rod 81 to be away from the first surface 821 from moving in the −X direction, which is the direction of the backward movement of the delivery rod 81.

Accordingly, since the solid target substance γ can be suppressed from returning to the −X direction when the delivery rod 81 is returned in the −X direction, one solid target substance 270 can be delivered each time the delivery rod 81 reciprocates.

(9) According to the first embodiment, the first surface 821 is inclined with respect to the X direction, which is the direction of the backward movement of the delivery rod 81, and the second surface 822 intersects the X direction at an angle closer to perpendicular thereto than the angle between the X direction and the first surface 821.

Accordingly, since the angle between the second surface 822 and the X direction, which is the direction of the forward movement of the delivery rod 81, is close to a right angle, even when the solid target substance 270 presses the second surface 822, the stopper 82 can be suppressed from moving toward the outside of the tube 80.

(10) According to the first embodiment, the stopper 82 includes the first surface 821 that is pressed via the solid target substance γ when the delivery rod 81 moves forward in the X direction. According to the first embodiment, the delivery rod 81 presses the first surface 821 via the solid target substance γ to move the stopper 82 toward the outside of the tube 80, and after the solid target substance γ moves away from the first surface 821 of the stopper 82, the delivery rod 81 is moved backward in the −X direction with the stopper 82 being in contact with the delivery rod 81.

Accordingly, the solid target substance 270 may be delivered in the X direction when the delivery rod 81 moves forward in the X direction, and the solid target substance 270 may not be delivered in the −X direction when the delivery rod 81 moves backward in the −X direction.

(11) According to the first embodiment, by further backward movement of the delivery rod 81 in a state with the stopper 82 stopped after the delivery rod 81 is moved backward in the −X direction to move the stopper 82 to the inside of the tube 80, a space for receiving the solid target substance β is formed between the receiving port 801 and the facing surface 803 and between the delivery rod 81 and the stopper 82.

Accordingly, when the delivery rod 81 is moved backward in the −X direction, the subsequent solid target substance 270 can be received.

(12) According to the first embodiment, the tube 80 is inclined so as to deliver the solid target substance 270 against gravity when the delivery rod 81 moves forward in the X direction.

Accordingly, since the solid target substance 270 is delivered against gravity, the height of the entire EUV light generation system 11 including the solid target substance replenishment device 260 can be suppressed, and the degree of freedom in installation can be improved. Since the solid target substance 270 is delivered against gravity not only in the supply pipe 41 but also in the tube 80, the adjacent solid target substances 270 are conveyed to the discharge port 410 in a state of being in contact with each other, and are pushed out one by one. Therefore, the solid target substance 270 can be stably delivered.

(13) According to the first embodiment, the stopper 82 moves while pivoting.

Accordingly, the stopper 82 can be moved by a simple movement mechanism such as the rotation shaft 825.

In other respects, the first embodiment is similar to the comparative example.

### 4. Delivery Device 8b in which Stopper 82 Moves Linearly

### 4.1 Configuration and Operation

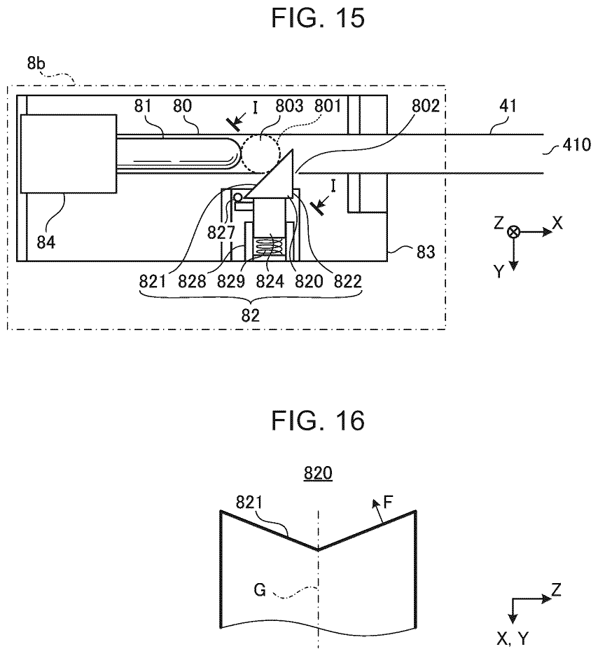

FIG. 15 schematically shows the configuration of a delivery device 8b according to a second embodiment. FIG. 15 is a view of the delivery device 8b viewed in the Z direction. In the second embodiment, the stopper 82 is supported by the base portion 83 via a slider 828 instead of the rotation shaft 825, and can move forward and backward linearly in parallel to the Y direction. In the second embodiment as well, the stopper 82 is movable in a plane intersecting the Z direction and movable in a plane away from the receiving port 801. More preferably, the stopper 82 is movable in a plane perpendicular to the Z direction.

The rod portion 824 is pressed in the −Y direction by the restoring force of the spring 829. When the delivery rod 81 moves forward in the X direction, the inclined first surface 821 of the tapered portion 820 is pressed by the delivery rod 81 via the solid target substance γ, and the stopper 82 is moved in the Y direction toward the outside of the tube 80, thereby forming a passage for moving the solid target substance γ between the receiving port 801 and the facing surface 803 in the tube 80.

When the delivery rod 81 is moved backward in the −X direction, the stopper 82 moves toward the inside of the tube 80 in the −Y direction by the restoring force of the spring 829, but when the stopper 82 abuts the stop pin 827, the movement of the stopper 82 in the −Y direction is restricted. At this time, the second surface 822 restricts the solid target substance d in the tube 80 from returning in the −X direction. Further, by further movement of the delivery rod 81 in the −X direction, a space for receiving the solid target substance γ supplied from the receiving port 801 is secured between the receiving port 801 and the facing surface 803.

### 4.2 Effect

(14) According to the second embodiment, the stopper 82 moves linearly.

Accordingly, since the rotation shaft 825 of the stopper 82 is not required, even when fine particles such as scraping debris of the solid target substance 270 are generated, adverse such as effects increasing of the frictional force of the rotation shaft 825 can be suppressed, and the durability of the delivery device 8b can be improved.

In other respects, the second embodiment is similar to the first embodiment.

### 5. Delivery Device 8b in which First Surface 821 Includes Groove

### 5.1 Configuration and Operation

FIG. 16 is a sectional view of a tapered portion 820 of the stopper 82 according to a first modification of the second embodiment. FIG. 16 shows a cross section of a portion of the tapered portion 820 along line I-I of FIG. 15. The first surface 821 of the tapered portion 820 includes a groove parallel to the XY plane. A reaction force F received by the solid target substance 270 from the first surface 821 when the delivery rod 81 presses the first surface 821 via the solid target substance 270 includes a directional component directing toward an imaginary plane G being parallel to the XY plane and passing through the center of the groove. Therefore, the solid target substance 270 is suppressed from being pressed against the wall surface on the −Z direction side, and biting is suppressed.

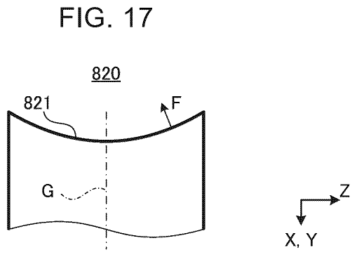

FIG. 17 is a sectional view of the tapered portion 820 of the stopper 82 in a second modification of the second embodiment. In the first modification the groove of the first surface 821 has a V-shaped cross-section. In the second modification, the groove of the first surface 821 may have a cylindrical surface or another concave curved surface, and in other respects the second modification may be similar to the first modification. Such a groove also suppresses biting.

Here, description is provided on a case that the first surface 821 includes a groove in the second embodiment. However, the first surface 821 may include a groove in the first embodiment.

### 5.2 Effect

(15) According to the first and second modifications, the stopper 82 includes the first surface 821 inclined with respect to the X direction, which is the direction of the forward movement of the delivery rod 81, and the first surface 821 includes the groove in the direction parallel to the XY plane parallel to both the X direction and the Y direction, which is the direction of the movement of the stopper 82.

Accordingly, when the delivery rod 81 presses the first surface 821 via the solid target substance 270, the position of the solid target substance 270 in the direction intersecting the groove can be stabilized.

### 6. Solid Target Substance Replenishment Device 260c Including First and Second Detectors D1, D2

### 6.1 Configuration

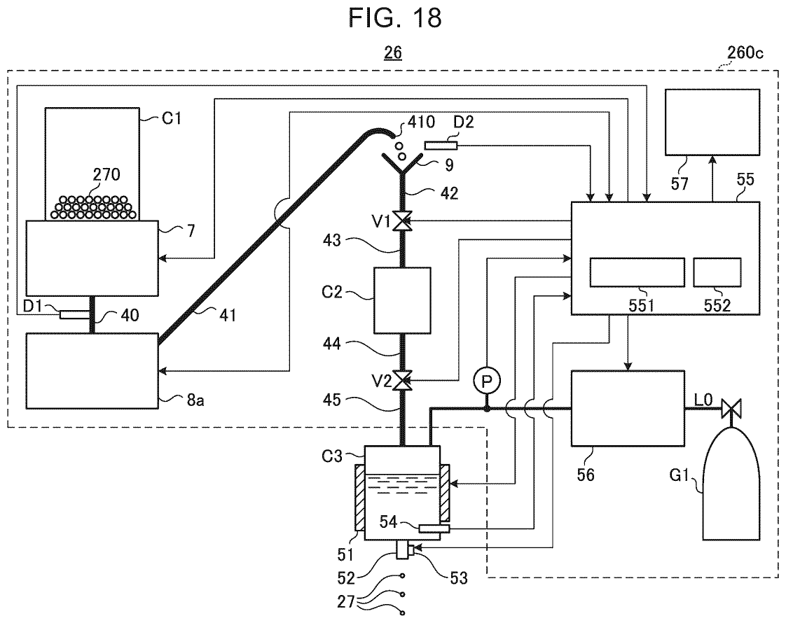

FIG. 18 shows the configuration of the droplet target generation device 26 of a third embodiment. In the third embodiment, a solid target substance replenishment device 260c includes first and second detectors D1, D2 and a display unit 57.

The first detector D1 is arranged in the supply pipe 40. The first detector D1 may detect a change in the electrical resistance of the supply pipe 40 or may detect a change in vibration. The second detector D2 is arranged in the vicinity of the discharge port 410. The second detector D2 may detect light output from a light source (not shown) and reflected by the solid target substance 270. The display unit 57 is a device that displays information in a visually recognizable manner, and may be an image display device or a light emitting element.

### 6.2 Operation

The first detector D1 transmits a first detection signal to the target supply processor 55 each time one solid target substance 270 passes through the supply pipe 40. Each time the first detection signal is received, the target supply processor 55 transmits a drive signal to the drive unit 84 of the delivery device 8a with a predetermined time difference from the first detection signal. Each time the drive unit 84 receives a drive signal, the drive unit 84 causes the delivery rod 81 to reciprocate once. The drive unit 84 transmits a reciprocal movement signal indicating that the delivery rod 81 has been reciprocated once to the target supply processor 55.

The second detector D2 transmits a second detection signal to the target supply processor 55 each time one solid target substance 270 is discharged from the discharge port 410. The target supply processor 55 monitors consistency of the reciprocal movement signal and the second detection signal.

As a first example of the operation of monitoring the consistency, when the reciprocal movement signal is received but the second detection signal is not received, the target supply processor 55 may cause the display unit 57 to display occurrence of an error state. Displaying the error state allows an operator of the EUV light generation system 11 to know that there may be biting or other malfunction in the delivery device 8a or the supply pipe 41.

As a second example of the operation of monitoring the consistency, when the time interval of the second detection signal is shorter than the time interval of the reciprocal movement signal, that is, when the plurality of solid target substances 270 are discharged from the discharge port 410 when the delivery rod 81 reciprocates one time, the target supply processor 55 may cause the display unit 57 to display occurrence of the error state. For example, when the size of the solid target substance 270 varies, the number of solid target substances 270 discharged from the discharge port 410 may be larger than the number of solid target substances 270 delivered from the delivery device 8a. When the number of solid target substances 270 to be replenished at one time is larger than a desired number, there is a possibility that the capacity of the load lock chamber C2 is exceeded or a possibility that thermal variation in the molten target container C3 is increased. Displaying the error state allows the operator of the EUV light generation system 11 to know that there is a possibility that the number of solid target substances 270 to be replenished is too large.

### 6.3 Effect

(16) According to the third embodiment, the solid target substance replenishment device 260c includes the first detector D1, the drive unit 84, and the target supply processor 55. The first detector D1 detects the solid target substance 270 passing through the feed device 7 and the supply pipe 40. The drive unit 84 causes the delivery rod 81 to move forward and backward in parallel to the X direction. The target supply processor 55 controls the drive unit 84 based on the detection result of the first detector D1.

Accordingly, it is possible to match the passing number of the solid target substances 270 passing through the feed device 7 and the supply pipe 40 and the passing number of the solid target substances 270 in the tube 80.

(17) According to the third embodiment, the solid target substance replenishment device 260c includes the second detector D2 and the target supply processor 55. The second detector D2 detects the solid target substances 270 passing through the path from the supply pipe 41 to the supply pipe 45. The target supply processor 55 determines the consistency between the forward and backward movement parallel to the X direction of the delivery rod 81 and the detection result of the second detector D2, and outputs the determination result.

Accordingly, it is possible to issue a warning when the passing number of the solid target substances 270 in the tube 80 does not match the passing number of the solid target substances 270 in the path from the supply pipe 41 to the supply pipe 45.

In other respects, the third embodiment is similar to the first embodiment. Alternatively, in the third embodiment, the stopper 82 may include the delivery device 8b that moves linearly, or the first surface 821 may include a groove.

### 7. Others

### 7.1 EUV Light Utilization Apparatus 6

FIG. 19 shows the configuration of the exposure apparatus 6a connected to the EUV light generation system 11. In FIG. 19, the exposure apparatus 6a as the EUV light utilization apparatus 6 (see FIG. 1) includes a mask irradiation unit 608 and a workpiece irradiation unit 609. The mask irradiation unit 608 illuminates, via a reflection optical system, a mask pattern of a mask table MT with the EUV light incident from the EUV light generation system 11. The workpiece irradiation unit 609 images the EUV light reflected by the mask table MT onto a workpiece (not shown) arranged on a workpiece table WT via a reflection optical system. The workpiece is a photosensitive substrate such as a semiconductor wafer on which photoresist is applied. The exposure apparatus 6a synchronously translates the mask table MT and the workpiece table WT to expose the workpiece to the EUV light reflecting the mask pattern. Through the exposure process as described above, a device pattern is transferred onto the semiconductor wafer, thereby an electronic device can be manufactured.

FIG. 20 shows the configuration of the inspection apparatus 6b connected to the EUV light generation system 11. In FIG. 20, the inspection apparatus 6b as the EUV light utilization apparatus 6 (see FIG. 1) includes an illumination optical system 603 and a detection optical system 606. The illumination optical system 603 reflects the EUV light incident from the EUV light generation system 11 to illuminate a mask 605 placed on a mask stage 604. Here, the mask 605 conceptually includes a mask blanks before a pattern is formed. The detection optical system 606 reflects the EUV light from the illuminated mask 605 and forms an image on a light receiving surface of a detector 607. The detector 607 having received the EUV light obtains the image of the mask 605. The detector 607 is, for example, a time delay integration (TDI) camera. A defect of the mask 605 is inspected based on the image of the mask 605 acquired by the above-described process, and for mask suitable manufacturing an electronic device is selected using the inspection result. Then, the electronic device can be manufactured by exposing and transferring the pattern formed on the selected mask onto the photosensitive substrate using the exposure apparatus 6a.

### 7.2 Supplement

The description above is intended to be illustrative and the present disclosure is not limited thereto. Therefore, it would be obvious to those skilled in the art that various modifications to the embodiments of the present disclosure would be possible without departing from the spirit and the scope of the appended claims. Further, it would be also obvious to those skilled in the art that the embodiments of the present disclosure would be appropriately combined.

The terms used throughout the present specification and the appended claims should be interpreted as non-limiting terms unless clearly described. For example, terms such as “comprise”, “include”, “have”, and “contain” should not be interpreted to be exclusive of other structural elements. Further, indefinite articles “a/an” described in the present specification and the appended claims should be interpreted to mean “at least one” or “one or more.” Further, “at least one of A, B, and C” should be interpreted to mean any of A, B, C, A+B, A+C, B+C, and A+B+C as well as to include combinations of any thereof and any other than A, B, and C.

What is claimed is:

1. A solid target substance replenishment device, comprising;
a solid target container configured to contain a solid target substance;
a first path through which the solid target substance supplied from the solid target container passes;
a delivery device including:
a tube including a receiving port for receiving the solid target substance having passed through the first path and a facing surface facing the receiving port;
a delivery rod configured to deliver the solid target substance in the tube by being caused to alternately move forward and backward in a length direction of the tube; and
a stopper configured to form a passage through which the solid target substance between the receiving port and the facing surface is moved in the tube by being moved toward an outside of the tube when the delivery rod moves forward, and restrict the target substance in the tube from returning between the receiving port and the facing surface by being moved toward an inside of the tube when the delivery rod moves backward; and
a second path through which the solid target substance delivered by the delivery device is replenished to a molten target container of an extreme ultraviolet light generation apparatus.

2. The solid target substance replenishment device according to claim 1,
wherein the stopper moves in a plane intersecting a movement direction of the solid target substance passing through the receiving port.

3. The solid target substance replenishment device according to claim 1,
wherein the stopper moves in a plane perpendicular to a movement direction of the solid target substance passing through the receiving port.

4. The solid target substance replenishment device according to claim 1,
wherein the stopper moves in a plane away from the receiving port.

5. The solid target substance replenishment device according to claim 1,
wherein the stopper moves by being pressed by the delivery rod when the delivery rod moves forward, and moves by a restoring force of a spring when the delivery rod moves backward.

6. The solid target substance replenishment device according to claim 1,
wherein the stopper includes a first surface that is pressed to the delivery rod via the solid target substance when the delivery rod moves forward.

7. The solid target substance replenishment device according to claim 6,
wherein the first surface is inclined with respect to a forward movement direction of the delivery rod.

8. The solid target substance replenishment device according to claim 6,
wherein the stopper further includes a second surface that restricts the solid target substance pressed by the delivery rod to be away from the first surface from moving in a backward movement direction of the delivery rod.

9. The solid target substance replenishment device according to claim 8,
wherein the first surface is inclined with respect to a forward movement direction of the delivery rod, and
the second surface intersects the forward movement direction of the delivery rod at an angle closer to be perpendicular thereto than an angle between the forward movement direction of the delivery rod and the first surface.

10. The solid target substance replenishment device according to claim 1,
wherein the stopper includes a first surface that is pressed via the solid target substance when the delivery rod moves forward, and
the delivery rod presses the first surface via the solid target substance to move the stopper toward the outside of the tube, and after the solid target substance is moved away from the first surface of the stopper, the delivery rod is moved backward with the stopper being in contact with the delivery rod.

11. The solid target substance replenishment device according to claim 1,
wherein, by the delivery rod being further moved backward in a state with the stopper stopped after the delivery rod is moved backward into the tube, a space for receiving the solid target substance is formed between the receiving port and the facing surface and between the delivery rod and the stopper.

12. The solid target substance replenishment device according to claim 1,
wherein the tube is inclined so as to deliver the solid target substance against gravity when the delivery rod moves forward.

13. The solid target substance replenishment device according to claim 1,
wherein the stopper moves while pivoting.

14. The solid target substance replenishment device according to claim 1,
wherein the stopper moves linearly.

15. The solid target substance replenishment device according to claim 1,
wherein the stopper includes a first surface inclined with respect to a forward movement of the delivery rod, and
the first surface includes a groove in a direction parallel to a surface parallel to both a forward movement direction of the delivery rod and a movement direction of the stopper.

16. The solid target substance replenishment device according to claim 1, further comprising:
a first detector configured to detect the solid target substance passing through the first path;
a drive unit configured to cause the delivery rod to move forward and backward; and
a processor configured to control the drive unit based on a detection result of the first detector.

17. The solid target substance replenishment device according to claim 1, further comprising:
a second detector configured to detect the solid target substance passing through the second path; and
a processor configured to determine consistency between forward and backward movement of the delivery rod and a detection result of the second detector.

18. An extreme ultraviolet light generation apparatus comprising:
the solid target substance replenishment device according to claim 1;
the molten target container configured to melt the solid target substance replenished by the solid target substance replenishment device to produce a molten target substance;
a nozzle configured to output the molten target substance produced in the molten target container;
a laser device configured to irradiate, with pulse laser light, the molten target substance having reached a predetermined region after being output from the nozzle; and
an EUV light concentrating mirror configured to concentrate extreme ultraviolet light emitted from plasma generated in the predetermined region.

19. An electronic device manufacturing method, comprising:
generating extreme ultraviolet light using an extreme ultraviolet light generation apparatus;
the extreme ultraviolet light to an outputting exposure apparatus; and
exposing a photosensitive substrate to the extreme ultraviolet light in the exposure apparatus to manufacture an electronic device,
the extreme ultraviolet light generation apparatus including:
a solid target substance replenishment device including:
a solid target container configured to contain a solid target substance;
a first path through which the solid target substance supplied from the solid target container passes;
a delivery device including:
a tube including a receiving port for receiving the solid target substance having passed through the first path and a facing surface facing the receiving port;
a delivery rod configured to deliver the solid target substance in the tube by being caused to alternately move forward and backward in a length direction of the tube; and
a stopper configured to form a passage through which the solid target substance between the receiving port and the facing surface is moved in the tube by being moved toward an outside of the tube when the delivery rod moves forward, and restrict the target substance in the tube from returning between the receiving port and the facing surface by being moved toward an inside of the tube when the delivery rod moves backward; and
a second path through which the solid target substance delivered by the delivery device is replenished to a molten target container of the extreme ultraviolet light generation apparatus;
the molten target container configured to melt the solid target substance replenished by the solid target substance replenishment device to produce a molten target substance;
a nozzle configured to output the molten target substance produced in the molten target container;
a laser device configured to irradiate, with pulse laser light, the molten target substance having reached a predetermined region after being output from the nozzle; and
an EUV light concentrating mirror configured to concentrate the extreme ultraviolet light emitted from plasma generated in the predetermined region.

20. An electronic device manufacturing method, comprising:
inspecting a defect of a mask by irradiating the mask with extreme ultraviolet light generated by an extreme ultraviolet light generation apparatus;
selecting a mask using a result of the inspection; and
exposing and transferring a pattern formed on the selected mask onto a photosensitive substrate,
the extreme ultraviolet light generation apparatus including:
a solid target substance replenishment device including:
a solid target container configured to contain a solid target substance;
a first path through which the solid target substance supplied from the solid target container passes;
a delivery device including:
a tube including a receiving port for receiving the solid target substance having passed through the first path and a facing surface facing the receiving port;
a delivery rod configured to deliver the solid target substance in the tube by being caused to alternately move forward and backward in a length direction of the tube; and
a stopper configured to form a passage through which the solid target substance between the receiving port and the facing surface is moved in the tube by being moved toward an outside of the tube when the delivery rod moves forward, and restrict the target substance in the tube from returning between the receiving port and the facing surface by being moved toward an inside of the tube when the delivery rod moves backward, and
a second path through which the solid target substance delivered by the delivery device is replenished to a molten target container of the extreme ultraviolet light generation apparatus;
the molten target container configured to melt the solid target substance replenished by the solid target substance replenishment device to produce a molten target substance;
a nozzle configured to output the molten target substance produced in the molten target container;
a laser device configured to irradiate, with pulse laser light, the molten target substance having reached a predetermined region after being output from the nozzle; and
an EUV light concentrating mirror configured to concentrate the extreme ultraviolet light emitted from plasma generated in the predetermined region.
